(19) United States
(12) Patent Application Publication
(10) Pub. No.: US 2014/0146166 A1
(43) Pub. Date: May 29, 2014

(54) APPARATUS AND METHOD FOR ALIGNING DISPLAY SUBSTRATE

(71) Applicant: Moon Kyu SHIN, Yongin-City (KR)

(72) Inventor: Moon Kyu SHIN, Yongin-City (KR)

(21) Appl. No.: 13/945,249

(22) Filed: Jul. 18, 2013

(30) Foreign Application Priority Data
Nov. 26, 2012 (KR) 10-2012-0134542

(51) Int. Cl. G01B 11/14

(52) U.S. Cl. CPC G01B 11/14
USPC 348/95; 356/401

(57) ABSTRACT

An apparatus for aligning a display substrate includes a substrate seater, a mark identification light reflective plate on the substrate seater, wherein the display substrate is positioned on the substrate seater and includes an alignment mark including a black organic film, and wherein the mark identification light reflective plate overlaps the alignment mark of the display substrate positioned on the substrate seater.

### CROSS-REFERENCE TO RELATED APPLICATIONS

This application is based on and claims priority from Korean Patent Application No. 10-2012-0134542, filed on Nov. 26, 2012, in the Korean Intellectual Property Office, the disclosure of which is incorporated herein in its entirety by reference.

### BACKGROUND

1. Field

Example embodiments relate to an apparatus and a method for aligning a display substrate, and more particularly, to an apparatus and a method for aligning a display substrate of an organic light emitting display device or a display substrate of a liquid crystal display device.

2. Description of the Prior Art

A display substrate, which is used to fabricate a flat panel display, such as a TFT-LCD (Thin Film Transistor-Liquid Crystal Display), a PDP (Plasma Display Panel), a EL (Electro Luminescent), or the like, may be aligned for fabrication, transport, and performance inspection of a structure. Alignment of a display substrate may be performed by measuring alignment marks formed on one surface of the display substrate. That is, the display substrate may be aligned by measuring an alignment mark formed on one surface of the display substrate, determining whether the measured alignment mark coincides with a predetermined alignment state, and transporting, e.g., moving, the display substrate until the alignment mark coincides with the alignment state, if the alignment mark does not initially coincide with the alignment state.

For example, the alignment mark may be made of a metal material having high reflectivity, e.g., chromium. Therefore, when a conventional display substrate is made of a material having high permeability, and the metal alignment mark is photographed using an optical measurement means, the metal alignment mark may be bright relative to a peripheral portion of the display substrate, i.e., relative to a region of the display substrate surrounding the metal alignment mark. As such, a boundary between the metal alignment mark and the peripheral portion is sufficiently clear to perform the measurement of the alignment mark.

### SUMMARY

Example embodiments provide an apparatus for aligning a display substrate, which can clearly distinguish an alignment mark made of an organic material.

Example embodiments also provide a method for aligning a display substrate, which can clearly distinguish an alignment mark made of an organic material.

According to an aspect of the example embodiments, there is provided an apparatus for aligning a display substrate including a substrate seater, the display substrate being positioned on the substrate seater, an alignment mark on the substrate seater, the alignment mark including a black organic film, and a mark identification light reflective plate on the substrate seater, the mark identification light reflective plate overlapping the alignment mark on the display substrate.

The alignment mark may be on a first surface of the display substrate, the substrate seater may be on a second surface of the display substrate, the second surface being opposite the first surface, and the mark identification light reflective plate may contact the second surface of the display substrate to support the display substrate.

The mark identification light reflective plate and the alignment mark may contact each other.

The mark identification light reflective plate may include a center portion and an edge portion, the alignment mark overlapping the center portion.

The mark identification light reflective plate may include a metal material.

The mark identification light reflective plate may include stainless steel.

The mark identification light reflective plate may include a same material as the substrate seater.

At least two line-shaped mark identification light reflective plates may be provided, the two mark identification light reflective plates being spaced apart from each other and parallel to each other, and the two mark identification light reflective plates overlap two diagonally arranged ends of the display substrate, respectively.

The display substrate may further include an organic black matrix, the black organic film of the alignment mark and the black matrix including a same material.

At least a part of the black matrix may overlap an edge of the mark identification light reflective plate.

The alignment mark may be on at least one corner portion of the display substrate.

The apparatus for aligning a display substrate nay further include a camera configured to photograph the alignment mark, the camera overlapping the mark identification light reflective plate.

The alignment mark of the display substrate may be inserted between the camera and the mark identification light reflective plate, and overlaps the camera and the mark identification light reflective plate.

The apparatus for aligning a display substrate may further include a camera configured to photograph the alignment mark, an image input unit receiving an input of an image photographed by the camera, an image storage unit storing images of a plurality of different alignment marks which have been pre-aligned and photographed, an image selection unit selecting the image that is equal or similar to the image input to the image input unit from the image storage unit, and an alignment controller determining a degree of misalignment of the display substrate by comparing the image input to the image input unit with the image selected by the image selection unit, and aligning the display substrate.

According to another aspect of the example embodiments, there is provided an apparatus for aligning a display including a substrate seater, the display substrate with an alignment mark being positioned on the substrate seater, a camera configured to photograph the alignment mark, an image input unit configured to receive an input of an image photographed by the camera, an image storage unit configured to store images of a plurality of different alignment marks which have been pre-aligned and photographed, an image selection unit configured to select an image that is equal to or similar to the image input to the image input unit from the image storage unit, and an alignment controller configured to determine a degree of misalignment of the display substrate by comparing the image input to the image input unit with the image selected by the image selection unit, and aligning the display substrate.

The apparatus for aligning a display substrate may further include a mark identification light reflective plate on the substrate seater to overlap the alignment mark of the display substrate.

The alignment mark may include black organic film.

The display substrate may further include an organic black matrix, the black organic film including a same material as the organic black matrix.

According to another aspect of the example embodiments, there is provided a method for aligning a display substrate including adjusting an alignment mark on the display substrate, such that the alignment mark overlaps a mark identification light reflective plate, photographing the alignment mark using light reflected from the mark identification light reflective plate, and aligning the display substrate by reading an image photographed by the camera.

Reading the image photographed by the camera may include selecting an image that is equal to or similar to the image photographed by the camera from images of a plurality of different alignment marks which have been pre-aligned and photographed, and determining a degree of misalignment of the display substrate by comparing the image photographed by the camera with the selected image.

### BRIEF DESCRIPTION OF THE DRAWINGS

The above and other objects, features and advantages will be more apparent from the following detailed description taken in conjunction with the accompanying drawings, in which:

FIG. 1 is a schematic perspective view of an apparatus for aligning a display substrate according to an embodiment;

FIG. 2 is a plan view of an apparatus for aligning a display substrate according to an embodiment;

FIG. 3 is a cross-sectional view taken along line III-III′ in FIG. 2;

FIG. 4 is a block diagram illustrating the configuration of an image processor of an apparatus for aligning a display substrate according to an embodiment;

FIG. 5 is a block diagram exemplarily showing an image processing procedure preformed by the image processor in FIG. 4;

FIG. 6 is a schematic perspective view of an apparatus for aligning a display substrate according to another embodiment; and

FIG. 7 is a cross-sectional view taken along line VII-VII′ in FIG. 6.

### DETAILED DESCRIPTION

The aspects and features of the example embodiments will be apparent by referring to the accompanying drawings. However, the example embodiments are not limited to the embodiments disclosed hereinafter, but can be implemented in diverse forms. The matters defined in the description, such as the detailed construction and elements, are nothing but specific details provided to assist those of ordinary skill in the art in a comprehensive understanding of the inventive concept, and the example embodiments are defined within the scope of the appended claims.

The term “on” that is used to designate that an element is on another element or located on a different layer or a layer includes both a case where an element is located directly on another element or a layer and a case where an element is located on another element via another layer or still another element. In the entire description of the example embodiments, the same drawing reference numerals are used for the same elements across various figures.

Although the terms “first, second, and so forth” are used to describe diverse constituent elements, such constituent elements are not limited by the terms. The terms are used only to discriminate a constituent element from other constituent elements. Accordingly, in the following description, a first constituent element may be a second constituent element.

In the description of the example embodiments, an “alignment mark” includes an alignment key, a global key, and a global key mark.

Hereinafter, preferred embodiments will be described in detail with reference to the accompanying drawings.

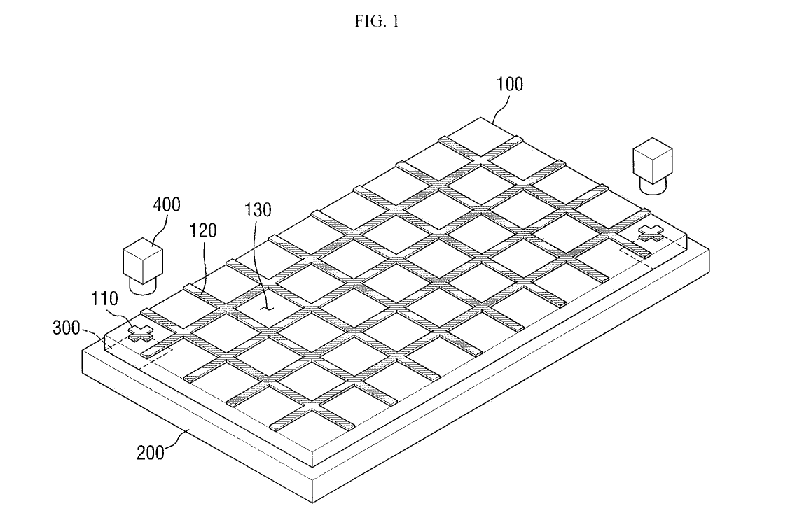

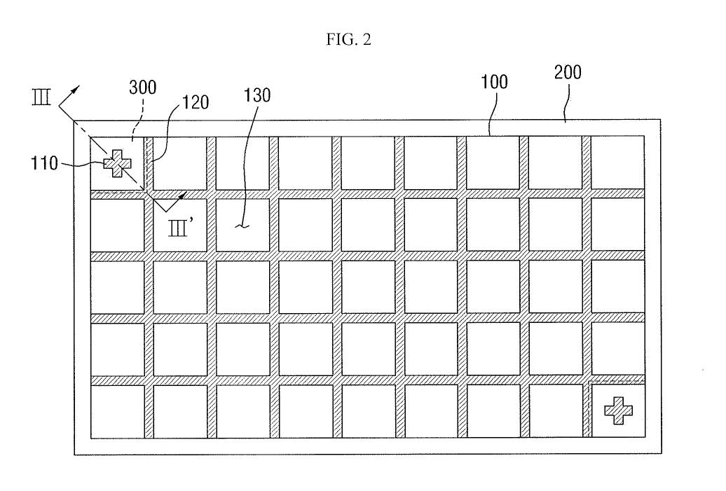

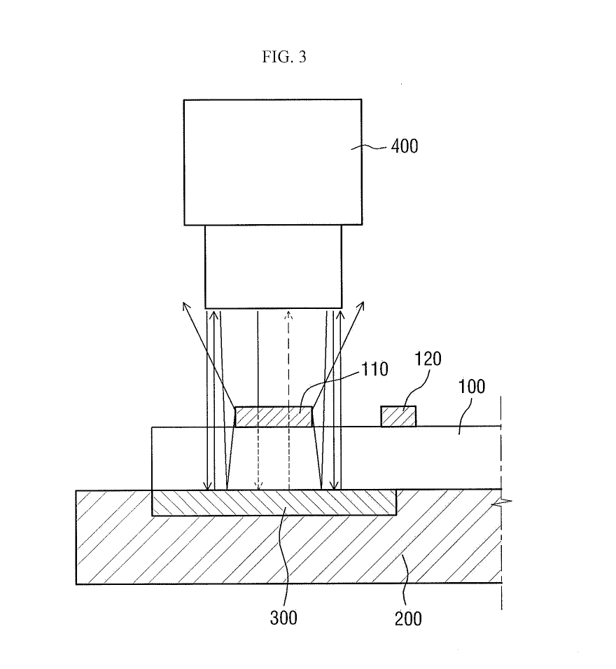

FIG. 1 is a schematic perspective view of an apparatus for aligning a display substrate 100 according to an embodiment. FIG. 2 is a plan view of an apparatus for aligning a display substrate 100 according to an embodiment, and FIG. 3 is a cross-sectional view taken along line in FIG. 2.

Referring to FIGS. 1 to 3, an apparatus for aligning a display substrate 100 is an apparatus that aligns a target display substrate. The target display substrate 100 may be aligned for fabrication, transport, and performance inspection of a structure. For example, the apparatus for aligning the display substrate 100 may be an apparatus that is used in a stage preceding a fabrication apparatus, a transport apparatus, or an inspection apparatus of the display substrate 100. In another example, the apparatus for aligning the display substrate 100 may be an apparatus that is integral with, e.g., part of, the fabrication apparatus, the transport apparatus, or the inspection apparatus of the display substrate 100.

The aligned display substrate 100 may be a simple substrate on which no structure is formed or a substrate on which at least a partial structure is formed. The structure formed on the display substrate 100 may be a completed structure or an uncompleted structure in intermediate stage. Further, the display substrate 100 that is aligned by the apparatus for aligning the display substrate 100 may be one sheet of structure or may include a plurality of laminated substrates. In the case where the display substrate 100 includes a plurality of substrates, the respective substrates may be adjacently laminated, e.g., to be in direct contact with each other, or may be laminated to be apart for a predetermined distance from each other to face each other.

FIGS. 1 and 2 show a case where a single display substrate 100 forms one display panel. In another embodiment not illustrated, the display substrate 100 may be a mother substrate that is divided into a plurality of display panels.

The display substrate 100 may include an alignment mark 110. The alignment mark 110 may be made of an organic material. In an exemplary embodiment, the alignment mark 110 may be formed of a black organic film. One or more alignment marks 110 may be formed on an edge portion of the display substrate 100. In an exemplary embodiment, the alignment mark 110 may be formed on at least one corner portion of the display substrate 100. According to an embodiment of FIGS. 1 and 2, two alignment marks 110 are formed on diagonal corners of the display substrates 100. For example, the alignment mark 110 may be cross-shaped, i.e., as “+”, and formed by embossing. However, the alignment mark 110 may be replaced by other various shapes, and may be formed by engraving.

On one surface of the display substrate 100, a black matrix 120 may be formed. The black matrix 120 may include a plurality of first black lines extending in a first direction and a plurality of second black lines extending in a second direction that crosses (for example, is orthogonal to) the first direction. A region that is defined through crossing of the first black lines and the second black lines may be a pixel region 130 in which a pixel is disposed.

The black matrix 120 may be made of an organic material. In an exemplary embodiment, the black matrix 120 may be made of a photosensitive organic material with a pigment, e.g., carbon black. Further, the black matrix 120 may be formed of a black organic film. Further, the black matrix 120 and the alignment mark 110 may be made of the same material. Further, the black matrix 120 and the alignment mark 110 may be formed through the same patterning process. That is, the black matrix 120 and the alignment mark 110 may be formed, e.g., simultaneously, using the same mask. In an exemplary embodiment, the thickness of the black matrix 120 may be substantially the same as the thickness of the alignment mark 110.

The display substrate 100, e.g., at least a peripheral portion of the region where the alignment mark 110 is formed, may be optically transparent. Here, “optically transparent” means at least partial transmission of the alignment mark identification light, e.g., light emitted from a camera to be explained below. For example, the transmittance of the alignment mark identification light through the peripheral portion of the region where the alignment mark 110 is formed on the display substrate 100 may be equal to or higher than 50%. In various embodiments, the transmittance may be equal to or higher than 80%, 90%, 95%, 97%, or 98%. The alignment mark identification light may be visible light or infrared rays, but is not limited thereto.

The apparatus for aligning the display substrate 100 may include a substrate seater 200 and a mark identification light reflective plate 300 installed on the substrate seater 200.

The substrate seater 200 provides a place on which the display substrate 100 is seated, e.g., positioned. The substrate seater 200 may be, for example, a stage or a transport rail of an apparatus for fabricating a display panel. The display substrate 100 may be seated on the substrate seater 200 by a transport robot, a transport rail, or a manual operation of an operator. The width of the substrate seater 200 may be equal to or larger than the width of the display substrate 100. Further, a plurality of substrate seaters 200 may be provided to be spaced apart from each other, and a transport rail may be installed between the substrate seaters 200.

A mark identification light reflective plate 300 may be installed on the substrate seater 200. The mark identification light reflective plate 300 may be disposed in a position where it overlaps the alignment mark 110 of the display substrate 100. For example, when two alignment marks 110 are formed on diagonal corners of the display substrate 100, one mark identification light reflective plates 300 may be positioned at each one of the two diagonal corners to overlap the two corresponding alignment marks 110. However, it is not necessary that all the alignment marks 110 of the seated display substrate 100 overlap the mark identification light reflective plate 300, e.g., a part of a plurality of alignment marks 110 of the display substrate 100 may not overlap the mark identification light reflective plate 300, and a part of a plurality of mark identification light reflective plate 300 may not overlap the alignment mark 110 of the display substrate 100.

The mark identification light reflective plate 300 may be formed of a material or a structure that can reflect the alignment mark identification light. For example, the mark identification light reflective plate 300 may be made of a pure metal material, e.g., chromium, silver, or aluminum. In another example, the mark identification light reflective plate 300 may be made of an alloy material, e.g., stainless steel. In still another example, the mark identification light reflective plate 300 may have a multilayer structure in which low refractive index films and high refractive index films are alternately laminated.

The mark identification light reflective plate 300 may have a size and a shape to completely cover the alignment mark 110. In an exemplary embodiment, the mark identification light reflective plate 300 may include a center portion and an edge portion, and the alignment mark 110 may overlap the center portion of the mark identification light reflective plate 300. In another exemplary embodiment, the mark identification light reflective plate 300 may be formed in a rectangular shape, and each side of the rectangle may be larger than a width of the corresponding alignment mark 110.

The mark identification light reflective plate 300 may be installed on an upper surface of the substrate seater 200. In an exemplary embodiment, a groove may be formed on the upper surface of the substrate seater 200, and the mark identification light reflective plate 300 may be disposed to be inserted into the groove. In other words, the mark identification light reflective plate 300 may have a flat shape embedded into the substrate seater 200, so an upper surface of the mark identification light reflective plate 300 may be level, e.g., coplanar, with an upper surface of the substrate seater 200, and may face a same direction as an upper surface of the substrate seater 200. In another exemplary embodiment, the mark identification light reflective plate 300 may be integrally formed with the substrate seater 200. In still another exemplary embodiment, the mark identification light reflective plate 300 may be made of the same material as the substrate seater 200.

The mark identification light reflective plate 300 may be positioned between the substrate seater 200 and the display substrate 100, such that the alignment mark 110 overlaps the mark identification light reflective plate 300. In some embodiments, the seated display substrate 100 may come in contact with the mark identification light reflective plate 300. In another embodiment, the display substrate 100 and the mark identification light reflective plate 300 may be spaced apart from each other. In this case, a vacancy or an optically transparent medium with respect to the identification light may be interposed between the display substrate 100 and the mark identification light reflective plate 300.

If the alignment mark 110 is on a first surface of the display substrate 100, the substrate seater 200 may be on a second surface, i.e., a surface opposite the first surface, of the display substrate 100. In this case, the mark identification light reflective plate 300 may come in contact with the second surface of the display substrate 100 to support the display substrate 100. In another example, the alignment mark 110 may be located on the second surface of the display substrate 100, and in this case, the mark identification light reflective plate 300 may come in contact with the alignment mark 110.

The mark identification light reflective plate 300 may overlap not only the alignment mark 110 but also the black matrix 120. In an exemplary embodiment, at least a part of the black matrix 120 may overlap the edge of the mark identification light reflective plate 300.

The apparatus for aligning the display substrate 100 may further include at least one camera 400. The camera 400 may be disposed on an upper portion of, e.g., above, the mark identification light reflective plate 300. The display substrate 100 may be seated on the substrate seater 200 so that the alignment mark 110 respectively overlaps the mark identification light reflective plate 300 and the camera 400.

The camera 400 may include an identification light generation unit and an identification light receiving unit. The identification light generation unit serves to generate the alignment mark identification light and to provide the alignment mark identification light to the side of the alignment mark 110 and the mark identification light reflective plate 300. The identification light receiving unit receives the identification light that is reflected from the alignment mark 110 and the mark identification light reflective plate 300. In another embodiment, the identification light generation unit may not be provided in the camera 400, but a separate alignment mark identification light generation device may be installed.

Referring to FIG. 3, if the substrate 100 is seated on the substrate seater 200, the identification light generation unit of the camera 400 emits the alignment mark identification light toward the side of the mark identification light reflective plate 300. The alignment mark identification light incident on the display substrate 100, on which the alignment mark 110 is not formed, passes through the display substrate 100, and reaches the mark identification light reflective plate 300. The alignment mark identification light that is incident on the mark identification light reflective plate 300 is reflected from the mark identification light reflective plate 300 to be incident on the side of the camera 400.

The alignment mark identification light that is directed toward the display substrate 100 covered by the alignment nark 110 is partially reflected from the surface of the alignment mark 110 and is partially absorbed in the alignment mark 110. A portion of the alignment mark identification light that penetrates the alignment mark 110 toward the mark identification light reflective plate 300 is reflected by the mark identification light reflective plate 300, and then is incident again on the side of the alignment mark 110. Here, since only partial light, i.e., light other than light that is reflected or completely absorbed, penetrates the alignment mark 110, the alignment mark identification light that is actually incident on the side of the camera 400 is greatly decreased. In other words, since a large portion of the alignment mark identification light emitted by the camera 400 toward the alignment mark 110 is reflected or absorbed, only a small portion of the initial light is incident back on the camera 400 from the alignment mark 110, e.g., as compared to light incident back from the uncovered substrate 100.

Accordingly, there is a difference between the quantity of light that is emitted, reflected, and then received in the region on which the alignment mark 110 is formed, as compared to the quantity of light that is emitted, reflected, and then received in the region on which the alignment mark 110 is not formed. Thus, the external shape of the alignment mark 110 can be confirmed. In particular, since the light, which is reflected from the mark identification light reflective plate 300 and is dashed against the side wall of the alignment mark 110, is reflected or scattered, the external pattern, of the alignment mark 110, i.e., a boundary between the alignment mark 110 and the peripheral portion, may become relatively darker than the peripheral portion. Accordingly, the boundary between the alignment mark 110 and the peripheral portion, i.e., a portion of the substrate 100 immediately surrounding the alignment marl 110, can be distinguished more clearly.

Further, if the alignment mark identification light is incident on the edge of the mark identification light reflective plate 300, the alignment mark identification light may be reflected to the center portion side of the display substrate 100 due to irregular reflection of the light at the edge. Accordingly, the driving portion of the apparatus for aligning the display substrate 100 may be affected and the structure disposed on the center portion of the display substrate 100 may be affected. To prevent this, a black matrix 120 that overlaps the edge of the mark identification light reflective plate 300 may be formed to prevent the alignment mark identification light from being incident to the edge of the mark identification light reflective plate 300. Accordingly, stable driving of the apparatus for aligning the display substrate 100 and minimization of the optical influence of the structure on the display substrate 100 can be sought.

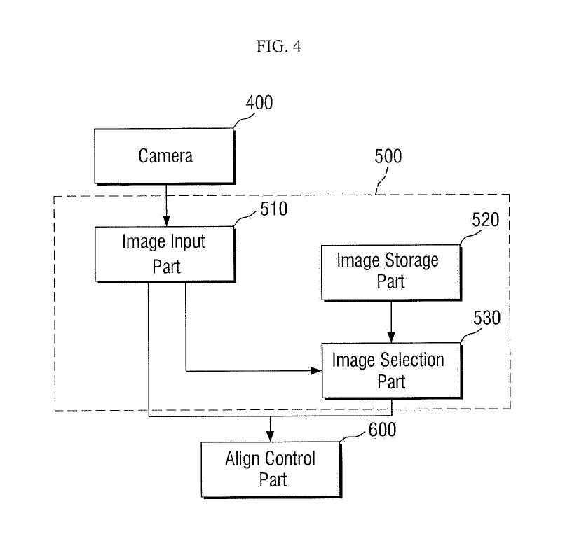

The apparatus for aligning the display substrate 100 may further include an image processor 500 and an alignment controller 600 for controlling the alignment state using an image of the alignment mark identification light that is incident on the identification light receiving unit of the camera 400, as will be explained in more detail below with reference to FIG. 4.

FIG. 4 is a block diagram illustrating the configuration of an image processor 500 of the apparatus for aligning the display substrate 100 according to an embodiment. Referring to FIG. 4, the image processor 500 may include an image input unit 510, an image storage unit 520, and an image selection unit 530.

The image input unit 510 may receive an input image 511 of the alignment mark 110 photographed by the camera 400 in a data form, and provide the image to the image selection unit 530 and the alignment controller 600.

The image storage unit 520 may store reference images of a plurality of alignment marks 110 and provide the reference images to the image selection unit 530. The reference images of the respective alignment marks 110 may be pre-designed specific reference images or reference images pre-photographed in various environments.

The image selection unit 530 may receive the input image 511 of the alignment mark 110 from the image input unit 510 and receive the reference images of the plurality of alignment marks 110 from the image storage unit 520. The image selection unit 530 may compare the input image 511 of the provided alignment mark 110 with the reference images of the respective alignment marks 110, selects the reference image of the alignment mark 110 that is equal to or most similar to the input image 511, and provide the selected reference image to the alignment controller 600.

The alignment controller 600 may analyze the difference between the selected reference image of the alignment mark 110 provided from the image selection unit 530 and the input image 511 of the alignment mark 110 provided from the image input unit 510 based on the selected reference image of the alignment mark 110, and correct the position of the display substrate 100 to correspond to the difference.

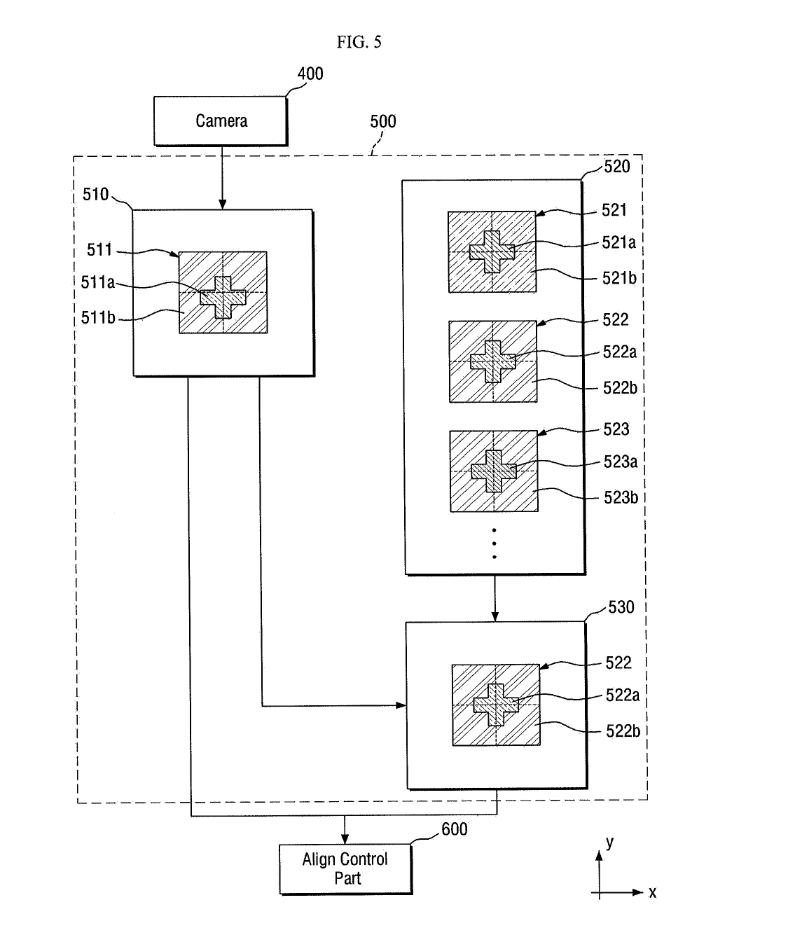

FIG. 5 is a block diagram exemplarily showing an image processing procedure preformed by the image processor 500 in FIG. 4.

Referring to FIG. 5, the image input unit 510 may receive the input image 511 of the alignment mark 110 photographed by the camera 400 in a data form. The input image 511 may include an input mark portion 511a and an input reflection portion 511b. The input mark portion 511a may be an image that corresponds to the photographed alignment mark 110, and the input reflection portion 511b may be an image that corresponds to the peripheral portion of the photographed alignment mark 110. If the display substrate 100 has been aligned, cross dotted lines that divide the input image 511 into four portions may correspond to the input mark portion 511a.

Here, that the cross dotted lines and the input mark portion 511a correspond to each other means that the input mark portion 511a is symmetric with respect to the first dotted line that extends in the first direction and is also symmetric with respect to the second dotted line which is orthogonal to the first dotted line and extends in the second direction. That is, if the display substrate 100 has been aligned, the position of the center of the input mark portion 511a may coincide with the position of the cross portion of the cross dotted lines. Further, due to a difference in medium between the alignment mark 110 and the peripheral portion, the input mark portion 511a and the input reflection portion 511b may have different brightness and saturation. In an exemplary embodiment illustrated in FIG. 5, the input mark portion 511a is shifted for a predetermined distance in −y direction from the position that corresponds to the cross dotted line. That is, camera 400 has photographed the alignment mark 110 of the display substrate 100 misaligned in −y direction and the peripheral portion and has provided this to the image input unit 510. The image input unit 510 may provide the input image 511 provided from the camera 400 to the image selection unit 530 and the alignment controller 600.

The image storage unit 520 may store the reference images of the plurality of alignment mark 110. In an exemplary embodiment illustrated in FIG. 5, the image storage unit 520 may store a first reference image 521, a second reference image 522, and a third reference image 523. The first reference image 521 may include a first reference mark portion 521a and a first reference reflection portion 521b, the second reference image 522 may include a second reference mark portion 522a and a second reference reflection portion 522b, and the third reference image 523 may include a third reference mark portion 523a and a third reference reflection unit 523b. The respective reference images may be pre-designed reference images. Further, the respective reference images may be images obtained by photographing the specific alignment mark 110 on the misaligned display substrate 100 in various environments. At least one reference image may differ from the remaining reference images, and preferably, all reference images may differ from one another. That is, the brightness and/or the saturation of at least one reference mark portion or reference reflection portion may differ from those of the remaining reference mark portions or reference reflection portions. FIG. 5 illustrates that the first to third reference mark portions 523a have the same shape. However, the shape of the first to third reference mark portions 523a is not limited thereto. The image storage unit 520 may provide the first reference image 521, the second reference image 522, and the third reference image 523 to the image selection unit 530.

The image selection unit 530 may receive the input image 511 from the image input unit 510, and receive the first reference image 521, the second reference image 522, and the third reference image 523 from the image storage unit 520. The image selection unit 530 may compare the input image 511 with the first reference image 521, the second reference image 522, and the third reference image 523, and select the reference image of the alignment mark 110 that is equal to or most similar to the input image 511. In an exemplary embodiment illustrated in FIG. 5, since the second reference image 522 is most similar to the input image 511 from the viewpoint of the shape, brightness, and saturation, the image selection unit 530 may select the second reference image 522. The image selection unit 530 may provide the selected second reference image 522 to the alignment controller 600.

The alignment controller 600 may analyze the difference between the input image 511 provided from the image input unit 510 and the selected second reference image 522 provided from the image selection unit 530 based on the selected second reference image 522. Since the input mark portion 511a of the input image 511 is shifted for a specified distance in −y direction as compared with the second reference mark portion 522a of the second reference image 522, the alignment controller 600 may determine that the display substrate 100 is shifted in −y direction from the alignment position and thus is misaligned. Accordingly, the alignment controller 600 may correct the position of the display substrate 100 to correspond to the difference between the input image 511 and the second reference image 522 by moving the display substrate 100 or the substrate seater 200. That is, the alignment controller 600 may fix the substrate seater 200 and move the display substrate 100 for the specified distance in y direction, or may fix the display substrate 100 and move the substrate seater 200 for the specified distance in −y direction.

According to the apparatus for aligning the display substrate 100 according to an embodiment, since the alignment mark 110 that is made of an organic material can be clearly distinguished, alignment of the display substrate can be performed accurately and promptly, and malfunction of the apparatus for aligning the display substrate 100 can be minimized. Further, since minute patterns can be laminated on the aligned display substrate 100, the inferiority rate of the display device can be reduced. Further, safe transport and normal inspection of the display substrate 100 can be performed. Further, even if the input image 511 has deviation due to an influence of environments or the like, an accurate alignment of the display substrate 100 can be sought through comparison of the input image with a plurality of reference images stored.

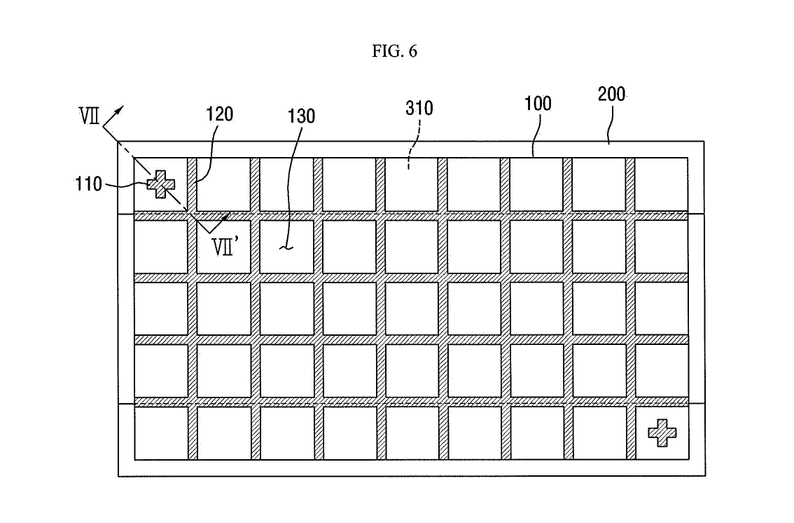

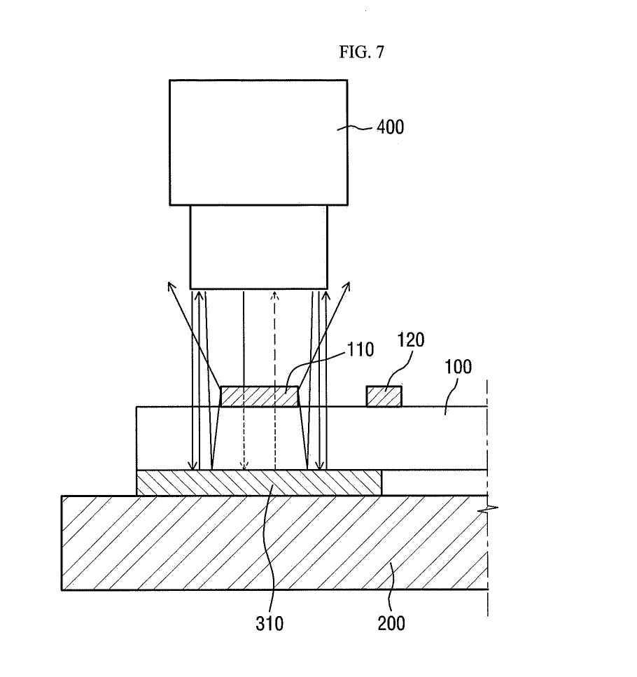

FIG. 6 is a schematic perspective view of the apparatus for aligning the display substrate 100 according to another embodiment, and FIG. 7 is a cross-sectional view taken along line VII-VII′ in FIG. 6. For convenience in explanation, the same reference numerals are given to substantially the same elements as the respective elements illustrated in FIGS. 1 to 5, and duplicate explanation thereof will be omitted.

Referring to FIG. 6, according to the apparatus for aligning the display substrate 100 according to another embodiment, at least two mark identification light reflective plates 310 may be provided. The two mark identification light reflective plates 310 may be spaced apart from each other, and may extend in parallel to each other in a line shape. For example, one mark identification light reflective plate 310 may extend along one edge of the seated substrate 100 to have its edge overlap a first end of the seated display substrate 100, and another mark identification light reflective plate 310 may extend along an opposite edge of the seated substrate 100 to overlap a second end of the substrate 100 positioned diagonally with respect to the first end. In an exemplary embodiment, the mark identification light reflective plate 310 may be formed to extend in an MD (Machine Direction) on a transport rail. In another exemplary embodiment, the mark identification light reflective plate 310 may be formed to extend in a TD (Transverse Direction) on the transport rail.

Referring to FIG. 7, the mark identification light reflective plate 310 may be formed on one surface of the flat substrate seater 200. That is, by the mark identification light reflective plate 310, the center portion of the display substrate 100 may be spaced apart from the substrate seater 200.

Hereinafter, the method for aligning the display substrate 100 according to an embodiment will be described. For convenience in explanation, the same reference numerals are given to substantially the same elements as the respective elements illustrated in FIGS. 1 to 5, and duplicate explanation thereof will be omitted.

The method for aligning the display substrate 100 according to an embodiment includes aligning the alignment mark 110 on the display substrate 100 with the mark identification light reflective plate 300 as follows. First, the display substrate 100 is positioned on the substrate seater 200. Then, the alignment mark 110 is irradiated with the alignment mark identification light, followed by photographing the alignment mark 110 using the light reflected from the mark identification light reflective plate 300. Next, the display substrate 100 is aligned by reading the image of the alignment mark 110 photographed by the camera 400. Here, aligning the display substrate 100 may be performed by moving the display substrate 100 or the substrate seater 200.

Further, reading the image of the alignment mark 110 photographed by the camera 400 may include selecting an image that is equal or similar to the image of the alignment mark 110 photographed by the camera 400 from the images of the plurality of different alignment marks 110 pre-aligned and photographed, and determining the degree of misalignment of the display substrate 100 by comparing the image of the alignment mark 110 photographed by the camera 400 with the selected image of the alignment mark 110.

According to embodiments, at least the following effects can be achieved. Since the alignment mark made of an organic material can be clearly distinguished, alignment of the display substrate can be performed accurately and promptly, and malfunction of the apparatus for aligning the display substrate can be minimized. Further, since minute patterns can be laminated on the aligned display substrate, the inferiority rate of the display device can be reduced. Furthermore, safe transport and normal inspection of the display substrate can be performed. In addition, even if an input image has deviation due to an influence of environments or the like, an accurate alignment of the display substrate can be sought through comparison of the input image with a plurality of reference images stored.

In contrast, when the alignment mark is made of an organic material having low reflectivity, when the organic alignment mark is photographed using the optical measurement means, a boundary between the alignment mark and the peripheral portion is unclear, thereby causing difficulties during measurement of the alignment mark. If the measurement of the alignment mark is difficult, the alignment of the display substrate may be delayed, and the alignment device of the display substrate may malfunction. Further, in the case where minute patterns are laminated on a misaligned display substrate, inferiority of a display device may be caused, and damage may occur during transportation of the display substrate. Further, due to wrong determination during inspection of the display substrate, a normal display substrate may be discarded or an inferior display substrate may be shipped.

While some example embodiments have been particularly shown and described, it will be understood by those of ordinary skill in the art that various changes in form and details may be made therein without departing from the spirit and scope of the inventive concept as defined by the following claims. It is therefore desired that the present embodiments be considered in all respects as illustrative and not restrictive, reference being made to the appended claims rather than the foregoing description to indicate the scope of the invention.

What is claimed is:

1. An apparatus for aligning a display substrate, comprising:
a substrate seater; and
a mark identification light reflective plate on the substrate seater,
wherein the display substrate is positioned on the substrate seater and includes an alignment mark including a black organic film, and
wherein the mark identification light reflective plate overlaps the alignment mark of the display substrate positioned on the substrate seater.

2. The apparatus for aligning a display substrate of claim 1, wherein:
the alignment mark is on a first surface of the display substrate,
the substrate seater is on a second surface of the display substrate, the second surface being opposite the first surface, and
the mark identification light reflective plate contacts the second surface of the display substrate to support the display substrate.

3. The apparatus for aligning a display substrate of claim 1, wherein the mark identification light reflective plate and the alignment mark contact each other.

4. The apparatus for aligning a display substrate of claim 1, wherein the mark identification light reflective plate includes a center portion and an edge portion, the alignment mark overlapping the center portion.

5. The apparatus for aligning a display substrate of claim 1, wherein the mark identification light reflective plate includes a metal material.

6. The apparatus for aligning a display substrate of claim 5, wherein the mark identification light reflective plate includes stainless steel.

7. The apparatus for aligning a display substrate of claim 1, wherein the mark identification light reflective plate includes a same material as the substrate seater.

8. The apparatus for aligning a display substrate of claim 1, wherein at least two line-shaped mark identification light reflective plates are provided, the two mark identification light reflective plates being spaced apart from each other and parallel to each other, and the two mark identification light reflective plates overlap two diagonally arranged ends of the display substrate, respectively.

9. The apparatus for aligning a display substrate of claim 1, wherein the display substrate further includes an organic black matrix, the black organic film of the alignment mark and the black matrix including a same material.

10. The apparatus for aligning a display substrate of claim 9, wherein at least a part of the black matrix overlaps an edge of the mark identification light reflective plate.

11. The apparatus for aligning a display substrate of claim 1, wherein the alignment mark is on at least one corner portion of the display substrate.

12. The apparatus for aligning a display substrate of claim 1, further comprising a camera configured to photograph the alignment mark, the camera overlapping the mark identification light reflective plate.

13. The apparatus for aligning a display substrate of claim 12, wherein the alignment mark of the display substrate is inserted between the camera and the mark identification light reflective plate, and overlaps the camera and the mark identification light reflective plate.

14. The apparatus for aligning a display substrate of claim 1, further comprising:
a camera configured to photograph the alignment mark;
an image input unit receiving an input of an image photographed by the camera;
an image storage unit storing images of a plurality of different alignment marks which have been pre-aligned and photographed;
an image selection unit selecting the image that is equal or similar to the image input to the image input unit from the image storage unit; and
an alignment controller determining a degree of misalignment of the display substrate by comparing the image input to the image input unit with the image selected by the image selection unit, and aligning the display substrate.

15. An apparatus for aligning a display substrate, comprising:
a substrate seater, the display substrate with an alignment mark being positioned on the substrate seater;
a camera configured to photograph the alignment mark;
an image input unit configured to receive an input of an image photographed by the camera;
an image storage unit configured to store images of a plurality of different alignment marks which have been pre-aligned and photographed;
an image selection unit configured to select an image that is equal to or similar to the image input to the image input unit from the image storage unit; and
an alignment controller configured to determine a degree of misalignment of the display substrate by comparing the image input to the image input unit with the image selected by the image selection unit, and aligning the display substrate.

16. The apparatus for aligning a display substrate of claim 15, further comprising a mark identification light reflective plate on the substrate seater to overlap the alignment mark of the display substrate.

17. The apparatus for aligning a display substrate of claim 16, wherein the alignment mark includes black organic film.

18. The apparatus for aligning a display substrate of claim 17, wherein the display substrate further comprises an organic black matrix, the black organic film including a same material as the organic black matrix.

19. A method for aligning a display substrate, comprising:
adjusting an alignment mark on the display substrate, such that the alignment mark overlaps a mark identification light reflective plate;
photographing the alignment mark using light reflected from the mark identification light reflective plate; and
aligning the display substrate by reading an image photographed by the camera.

20. The method for aligning a display substrate of claim 19, wherein reading the image photographed by the camera includes:
selecting an image that is equal to or similar to the image photographed by the camera from images of a plurality of different alignment marks which have been pre-aligned and photographed; and
determining a degree of misalignment of the display substrate by comparing the image photographed by the camera with the selected image.
